(19) United States
(12) Patent Application Publication
(10) Pub. No.: US 2026/0304341 A1
(43) Pub. Date: Oct. 1, 2026

(54) METHODS AND SYSTEMS FOR MANAGING NETWORK REGISTRATION

(71) Applicant: Comcast Cable Communications, LLC, Philadelphia, PA (US)

(72) Inventors: Kai REN, Garnet Valley, PA (US); Sandeep ADAPALA, King of Prussia, PA (US); Manjo Jose KUNNAMKOTT, Warrington, PA (US); Karl SCHLIEBER, Kirkland, WA (US)

(21) Appl. No.: 19/094,372

(22) Filed: Mar. 28, 2025

(51) Int. Cl. H04W 60/02

(52) U.S. Cl. CPC H04W 60/02

(57) ABSTRACT

Methods and systems for managing network registration are disclosed. A request to register a user device with a network may be received by at least one computing device associated with the network. Based on the request, the computing device(s) may determine a registration interval for the user device. Based on determining at least one parameter associated with the network, the computing device(s) may modify the registration interval for the user device. The user device may be caused to re-register with the network based on the modified registration interval.

### BACKGROUND

A user device (e.g., user equipment) may need to register with a network to connect to the network and access services provided by the network. The user device may periodically re-register with the network to maintain the connection with the network. The user device may be associated with a registration interval (e.g., time interval), and may re-register with the network based on the registration interval. However, the registration interval may be fixed (e.g., static), and therefore may not adapt to changing network conditions.

### SUMMARY

Systems and methods for managing network registration are described herein. A user device may connect to a network and receive information indicative of a registration interval. The user device may periodically re-register with the network, based on the registration interval, to maintain the connection with the network. Parameters of the network may be determined. If the network parameters indicate changing network conditions, the registration interval for the user device may be modified. The user device may periodically re-register with the network, based on the modified registration interval, to maintain the connection with the network based on the modified registration interval. Dynamically adjusting the registration interval for the user device based on changing network conditions may enable the network to better manage large-scale user device registration events, such as those that occur during times of congestion or service degradation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 shows an example system.

FIG. 2A shows an example method.

FIG. 2B shows an example method.

FIG. 3 shows an example method.

FIG. 4 shows an example method.

FIG. 5 shows an example method.

FIG. 6 shows an example computing device.

### DETAILED DESCRIPTION

User device (e.g., user equipment) registration is a fundamental process that ensures that user devices are connected to a network (e.g., a 5G core network) and can access services provided by the network. To register with the network, a user device may send an initial registration request to the network, such as to one or more computing devices associated with the network. Based on receiving the initial registration request, the network may connect the user device to the network, thereby enabling the user device to access the services provided by the network. Further, the network may determine a registration interval for the user device and send information indicating the registration interval to the user device. The user device may periodically send a request to re-register with the network based on the registration interval. For example, if the registration interval is twenty minutes, the user device may send a request to re-register with the network every twenty minutes. Such re-registration requests may enable the user device to maintain the connection with the network.

However, the registration interval may be fixed (e.g., static). A fixed registration interval may not dynamically adapt to changing network conditions, such as service degradation in the network (e.g., overloaded Access and Mobility Management Function (AMF), packet loss, signaling failures, congestion, server overloads, sudden spikes in traffic, etc.). That is, if the registration interval is twenty minutes, the user device may send a request to re-register with the network every twenty minutes regardless of changing network conditions.

Such static registration intervals may be particularly problematic if the network faces a service degradation event that causes a large quantity of user devices to send a re-registration request to the network. Without any adaptive mechanism to stagger or control these re-registration attempts, all user devices in a degraded area may attempt to re-register simultaneously. For example, thousands or millions of user devices could attempt to re-register at the same time. This surge (e.g., storm) of re-registration requests may overwhelm the network. The network may be unable to process the large quantity of re-registration requests in a timely manner.

As the network struggles to handle the re-registration load, services for all connected user devices (both user devices experiencing issues and user devices that were initially unaffected by the service degradation event) may begin to degrade. These connected user devices may experience dropped calls and/or communication sessions. Voice calls, video streaming, and data services may be dropped as the network resources are redirected to process the registration storm. Further, the surge of re-registration requests can lead to crashes or further slowdowns in the core network components, creating widespread instability in the network. As the network works through the surge of re-registration requests, normal service requests (e.g., session establishment, mobility management) may be delayed, leading to increased latency and/or a poor user experience. In severe cases, the registration storm may cause a significant portion of the network to become unavailable. User devices may experience difficulty accessing services, leading to service outages in affected regions. This may impact individual users as well as critical Internet of Things (IoT) devices, enterprise applications, and/or emergency services that rely on reliable network connectivity. This service degradation may create a feedback loop, where the user devices continuously try to re-register with the network at fixed intervals, further exacerbating the problem. As such, improved techniques for managing network registration are needed.

Described here are improved techniques for managing network registration. The techniques described herein leverage adaptive registration intervals and intelligent decision-making processes to prevent registration storms, thereby mitigating the impacts of network service degradation. The registration interval for user devices connected to a network may be dynamically adjusted in real-time based on various factors, such as network conditions, network parameters, user device behavior, and/or the like. By dynamically adjusting the registration interval for user devices based on network conditions, network parameters and/or user device behavior, re-registration attempts may be efficiently staggered, thereby preventing the network from simultaneously receiving an overwhelming quantity of re-registration attempts. As such, the network may be able to better manage large-scale user device registration events, such as those that occur during times of congestion or service degradation, and the network may remain available even during periods of heavy degradation.

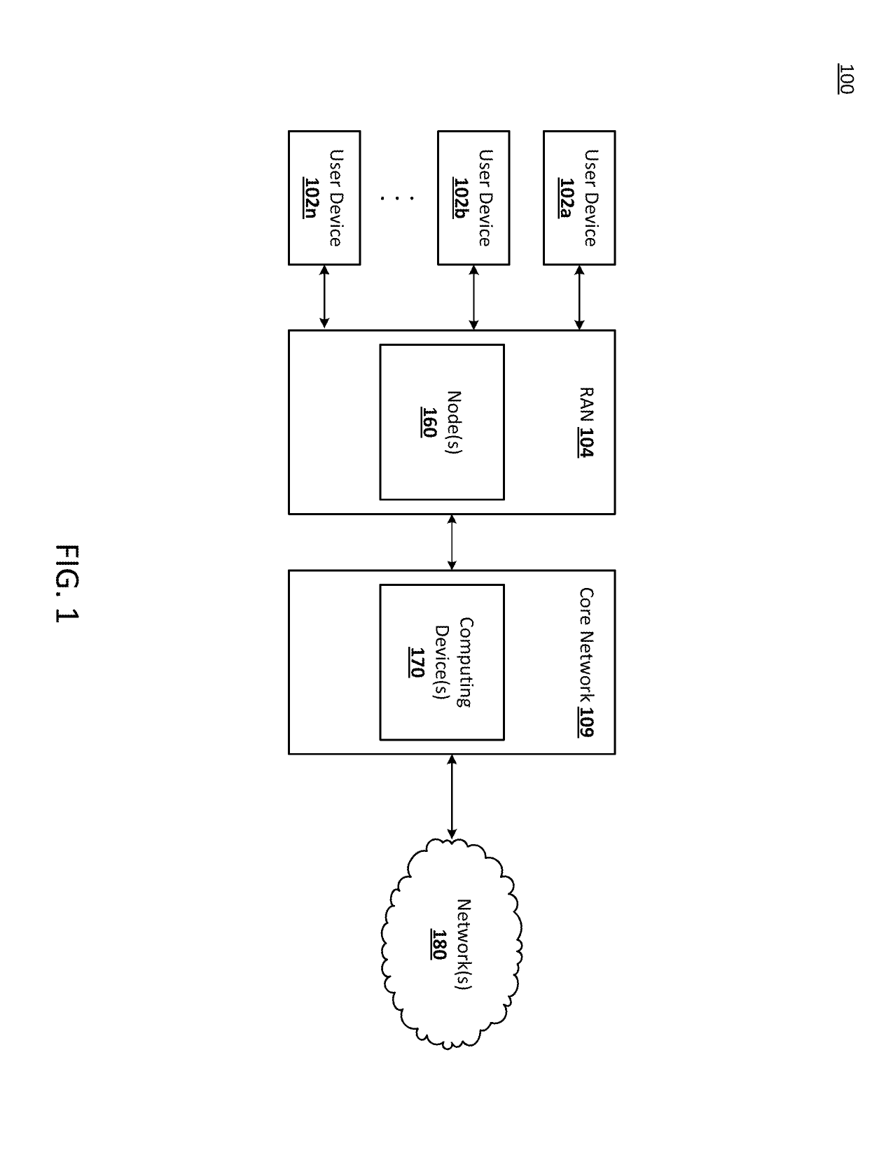

FIG. 1 shows an example system 100. The system 100 may comprise a plurality of user devices 102a-n, a radio access network (RAN) 104, a core network 109, and one or more networks 180. Each of the plurality of user devices 102a-n may comprise a mobile device, a smart phone, a tablet computer, a smartphone, a laptop, a portable gaming device, a computer, an Internet of Things (IoT) device, a wearable computing device, and/or the like. The RAN 104 may employ a new radio (NR) technology to communicate with the plurality of user devices 102a-n. The RAN 104 may also be in communication with the core network 109.

The RAN 104 may comprise one or more nodes 160. Each of the node(s) 160 may comprise, for example, a gNodeBase (gNode-B), an Evolved Node B (eNode-B), or any other type of base station or node. The RAN 104 may comprise any number of nodes. Each of the node(s) 160 may comprise one or more transceivers for communicating with the plurality of user devices 102a-n. Each of the node(s) 160 may implement MIMO, MU-MIMO, and/or digital beamforming technology. Thus, each of the node(s) 160, for example, may use multiple antennas to transmit wireless signals to, and receive wireless signals from, the user device 102a. Each of the node(s) 160 may be associated with a particular cell (not shown) and may be configured to handle radio resource management decisions, handover decisions, scheduling of users in the uplink and/or downlink, and the like. The node(s) 160 may communicate with one another over an Xn interface, for example.

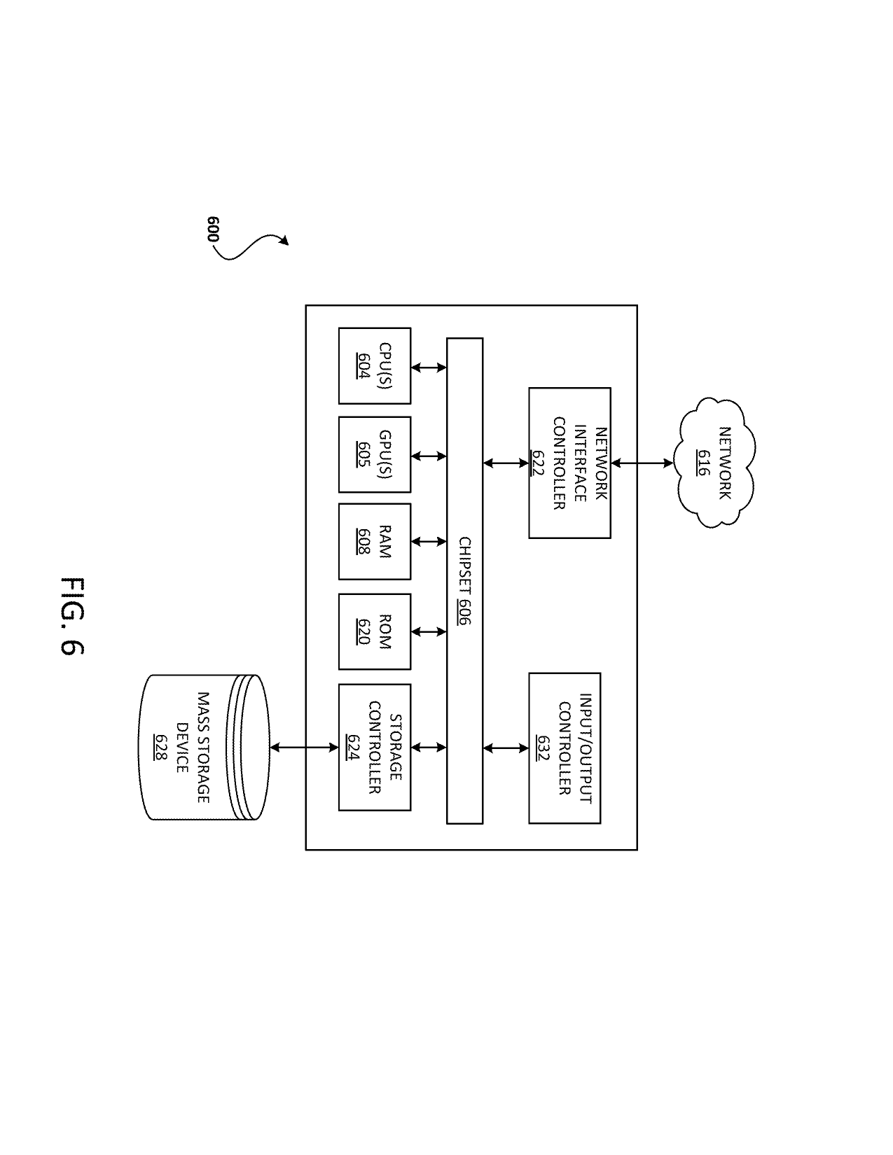

The core network 109 may comprise a 5G core network (5GC). The core network 109 may offer numerous communication services to customers who are interconnected by the RAN 104. The core network 109 may comprise a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless and/or network communications or a computer system, such as computing device 600 shown in FIG. 6.

The core network 109 may comprise at least one computing device 170. The computing device(s) 170 may comprise, for example, an access and mobility management function (AMF), a Session Management Function (SMF), one or more User Plane Functions (UPFs), a Home Subscriber Server (HSS), a Network Exposure Function (NEF), a Policy Control Function (PCF), a Network Health Score Function (NHSF), and a Shared Data Layer Function (SDL). The HSS may be split into an Authentication Server Function (AUSF), a User Data Management Function (UDM), and a User Data Repository (UDR). While each of the foregoing elements may be components of the core network 109, it may be appreciated that any one of these elements may be owned and/or operated by an entity other than the core network operator. Each of the network functions may directly connect to one another and/or may communicate via routing agents such as a diameter routing agent or message buses.

The computing device(s) 170 (e.g., the UPF(s) of the core network 109) may provide the plurality of user devices 102a-n with access to the network(s) 108 to facilitate communications between the plurality of user devices 102a-n and other devices. The network(s) 108 may comprise a Packet Data Network (PDN), such as the internet, ethernet networks, or any type of network that exchanges packets of data. The UPFs may receive traffic steering rules from the SMF. In addition to providing access to packet data networks, the UPFs may be responsible packet routing and forwarding, policy rule enforcement, quality of service handling for user plane traffic, and/or downlink packet buffering.

A first user device of the plurality of user devices 102a-n may send a request to register with the core network 109. The first user device may send the request to register with the core network 109 to connect to the core network 109, and thereby gain access to the network(s) 108. The first user device may send the request to register with the core network 109 to the node(s) 160. The node(s) 160 may forward the request to the computing device(s) 170. The computing device(s) 170 may receive the request to register the first user device with the core network 109.

Based on (e.g., in response to) receiving the request to register the first user device with the core network 109, the computing device(s) 170 may connect the first user device with the core network 109. The computing device(s) 170 may send a message back to the first user device indicating that the request to register with the core network 109 has been accepted (e.g., approved). The computing device(s) 170 may determine a first registration interval (e.g., initial registration interval) for the first user device. The computing device(s) 170 may determine the first registration interval for the first user device based on as network conditions, mobility of the first user device, and/or device type. The computing device(s) 170 may determine the first registration interval for the first user device based on (e.g., in response to) connecting the first user device with the core network 109. The computing device(s) 170 may send information indicative of the first registration interval to the first user device.

The first user device may receive information indicative of the first registration interval. Based on (e.g., in response to) receiving information indicative of the first registration interval, the first user device may periodically send a request to re-register with the core network 109. For example, if the first registration interval is forty-five minutes, the first user device may send a request to re-register with the core network 109 every forty-five minutes. Such re-registration requests may enable the first user device to maintain the connection with the core network 109.

Likewise, a second user device of the plurality of user devices 102a-n may send a request to register with the core network 109. The second user device may send the request to register with the core network 109 to connect to the core network 109, and thereby gain access to the network(s) 108. The second user device may send the request to register with the core network 109 to the node(s) 160. The node(s) 160 may forward the request to the computing device(s) 170. The computing device(s) 170 may receive the request to register the second user device with the core network 109.

Based on (e.g., in response to) receiving the request to register the second user device with the core network 109, the computing device(s) 170 may connect the second user device with the core network 109. The computing device(s) 170 may send a message back to the second user device indicating that the request to register with the core network 109 has been accepted (e.g., approved). The computing device(s) 170 may determine a second registration interval (e.g., initial registration interval) for the second user device. The computing device(s) 170 may determine the second registration interval for the second user device based on as network conditions, mobility of the second user device, and/or device type. The second registration interval may be different from, or the same as, the first registration interval. The computing device(s) 170 may determine the second registration interval for the second user device based on (e.g., in response to) connecting the second user device with the core network 109. The computing device(s) 170 may send information indicative of the second registration interval to the second user device.

The second user device may receive the information indicative of the second registration interval. Based on (e.g., in response to) receiving the information indicative of the second registration interval, the second user device may periodically send a request to re-register with the core network 109. For example, if the second registration interval is forty-five minutes, the second user device may send a request to re-register with the core network 109 every forty-five minutes. Such re-registration requests may enable the second user device to maintain the connection with the core network 109.

The computing device(s) 170 (e.g., the NHSF) may determine (e.g., monitor) at least one parameter associated with the core network 109. The at least one parameter may comprise one or more of a congestion level, a load on one or more network components (e.g., on any of the computing device(s) 170 and/or any other elements or functions of the core network 109), a latency level, a network speed, a throughput, or a level of packet loss. Determining (e.g., monitoring) the network parameter(s) may comprise periodically requesting data indicating values of the network parameter(s) from one or more components of the core network 109. For example, determining (e.g., monitoring) the network parameter(s) may comprise periodically requesting data indicating values of the network parameter(s) from the SDL. The one or more components of the core network 109, such as the SDL, may receive the request for the data indicating the values of the network parameter(s). Based on receiving the request for the data indicating the values of the network parameter(s), the one or more components of the core network 109, such as the SDL, may send the data indicating the values of the network parameter(s) to the computing device(s) 170 (e.g., the NHSF).

The computing device(s) 170 may determine a health score associated with the core network 109. The computing device(s) 170 may determine a health score associated with the core network 109 based on the determined (e.g., monitored) parameter(s). The computing device(s) 170 may determine a health score associated with the core network 109 based on receiving the data indicating the values of the network parameter(s). Determining the health score associated with the core network 109 may comprise determining a value of a network health score function. The value of each of the network parameter(s) may be input into the network health score function. The network health score function may output the health score associated with the core network 109. If the health score satisfies (e.g., is equal to or above) a predetermined threshold, this may indicate that the core network 109 is not experiencing a service degradation. Conversely, if the health score does not satisfy (e.g., is less than) a predetermined threshold, this may indicate that the core network 109 is experiencing a service degradation.

The computing device(s) 170 may determine that the registration interval for a subset of the plurality of user devices 102a-n needs to be modified. The computing device(s) 170 may determine that the registration interval for the subset of the plurality of user devices 102a-n needs to be modified based on determining (e.g., monitoring) the parameter(s) associated with the core network 109. The computing device(s) 170 may determine that the registration interval for the subset of the plurality of user devices 102a-n needs to be modified based on (e.g., in response to) determining that the core network 109 is experiencing a service degradation. For example, the computing device(s) 170 may determine that the registration interval for the subset of the plurality of user devices 102a-n needs to be modified based on (e.g., in response to) determining that the health score does not satisfy the predetermined threshold. The subset of the plurality of user devices 102a-n may comprise those user devices that are likely to attempt re-registration based on the health score failing to satisfy the predetermined threshold.

To determine the subset of the plurality of user devices 102a-n for which to modify the registration interval, the computing device(s) 170 may determine a range of subscriber identifiers, such as a range of Subscriber Identity Modules (SIMs), for which to modify the registration interval. The range of subscriber identifiers may be indicated by a predetermined policy associated with the core network 109 that is managed by the PCF. The policy may indicate, for example, to modify the registration interval for an International Mobile Subscriber Identity (IMSI) range of 123456000000000-123456999999999. The computing device(s) 170 may determine the subset of the plurality of user devices 102a-n based on determining which of the plurality of user devices 102a-n are associated with a subscriber identifier that falls within the range. For example, the computing device(s) 170 may determine that the first user device, but not the second user device, belongs to the subset of the plurality of user devices 102a-n if the first user device, but not the second user device, has a subscriber identifier that falls within the range.

Additionally, or alternatively, to determine the subset of the plurality of user devices 102a-n for which to modify the registration interval, the computing device(s) 170 may determine a priority level associated with each of the plurality of user devices 102a-n. The priority level associated with each user device among the plurality of user devices 102a-n may indicate if that user device is a high priority user device or a low priority user device. High priority user devices may comprise user devices associated with emergency services, user devices associated with enterprise applications, critical IoT devices, and/or the like. Low priority user devices may comprise user devices that are idle, user devices that are considered to be non-essential, and/or any other user devices that have not been assigned a high priority level. The computing device(s) 170 may determine the subset of the plurality of user devices 102a-n to be the user devices that have a specific priority level. For example, the computing device(s) 170 may determine the subset of the plurality of user devices 102a-n to be the low priority user devices (e.g., the computing device(s) 170 may determine that the first user device, but not the second user device, belongs to the subset of the plurality of user devices 102a-n if the first user device is a low priority device and the second user device is a high priority device). Alternatively, the computing device(s) 170 may determine the subset of the plurality of user devices 102a-n to be the high priority user devices.

The computing device(s) 170 may modify the registration interval for the subset of the plurality of user devices 102a-n. Modifying the registration interval for the subset of the plurality of user devices 102a-n may comprise lengthening or shortening the registration interval for each of the subset of the plurality of user devices 102a-n. Lengthening the registration interval for the subset of the plurality of user devices 102a-n may cause each of the subset of the plurality of user devices 102a-n to delay sending a re-registration request to the core network 109. Conversely, shortening the registration interval for the subset of the plurality of user devices 102a-n may cause each of the subset of the plurality of user devices 102a-n to send a re-registration request to the core network 109 earlier than they otherwise may have. The registration interval for the user devices that do not belong to subset of the plurality of user devices 102a-n may remain unchanged, enabling the user devices that do not belong to subset of the plurality of user devices 102a-n to re-register based on their initial registration intervals. Modifying the registration interval for the subset of the plurality of user devices 102a-n may comprise randomizing the registration interval for each of the subset of the plurality of user devices 102a-n. Randomizing the registration interval for each of the subset of the plurality of user devices 102a-n may comprise randomly determining a registration interval, within a predetermined range of registration intervals, for each of the subset of the plurality of user devices 102a-n. Modifying the registration interval for only the subset of the plurality of user devices 102a-n enables the core network 109 to stagger re-registration attempts from the plurality of user device 102a-n.

The computing device(s) 170 may cause the subset of the plurality of user devices 102a-n to re-register with the core network 109 based on the modified registration intervals. To cause the subset of the plurality of user devices 102a-n to re-register with the core network 109 based on the modified registration intervals, the computing device(s) 170 may send (e.g., push) information indicating each of the modified registration intervals to the corresponding user device among the subset of the plurality of user devices 102a-n. Each of the subset of the plurality of user devices 102a-n may receive the corresponding modified registration interval.

The subset of the plurality of user devices 102a-n may attempt to re-register with the core network 109 based on the modified registration intervals. The user devices that do not belong to subset of the plurality of user devices 102a-n may attempt to re-register with the core network 109 based on their initial registration intervals, ensuring that registration attempts are spaced out intelligently, thereby reducing signaling congestion during service degradation. Staggering re-registration attempts from the plurality of user device 102a-n may prevent a registration storm and/or may prevents the registration storm from escalating and spreading to other parts of the core network 109. This localized control may prevent cascading failures and may ensure stability of the core network 109.

As described above, the first user device, but not the second user device, may belong to the subset of the plurality of user devices 102a-n. As such, the computing device(s) 170 may modify (e.g., lengthen or shorten) the first registration interval for the first user device, but may not modify the second registration interval for the second first user device. The modified first registration interval may be different from the second registration interval associated with the second user device. The computing device(s) 170 may cause the first user device to re-register with the core network 109 based on the modified first registration interval. Causing the first user device to re-register with the core network 109 based on the modified first registration interval may comprise sending information indicative of the modified first registration interval to the first user device. The first user device may send a first request to re-register with the core network 109 based on the modified first registration interval. The second user device may send a second request to re-register with the core network 109 based on the second registration interval. The core network 109 may receive the first request at a first time and may receive the second request at a second time. If the modified first registration interval is different from the second registration interval associated with the second user device, the first time may be different from the second time. For example, if the modified first registration interval is longer than the second registration interval, the second time may occur before the first time. If the modified first registration interval is shorter than the second registration interval, the second time may occur after the first time.

The computing device(s) 170 (e.g., the NHSF) may continue to determine (e.g., monitor) the parameter(s) associated with the core network 109. For example, the computing device(s) 170 may continue to determine (e.g., monitor) one or more of a congestion level, a load on one or more network components (e.g., on any of the computing device(s) 170 and/or any other elements or functions of the core network 109), a latency level, a network speed, a throughput, or a level of packet loss.

The computing device(s) 170 may determine an updated health score associated with the core network 109. The computing device(s) 170 may determine the updated health score associated with the core network 109 based on the determined (e.g., monitored) parameter(s). The computing device(s) 170 may determine that the core network 109 is operating normally again (e.g., that the core network 109 is no longer experiencing a service degradation). The computing device(s) 170 may determine that the core network 109 is operating normally again based on determining that the updated health score satisfies the threshold.

If the computing device(s) 170 determine that the core network 109 is operating normally again, the computing device(s) 170 may cause the modified registration intervals for the subset of the plurality of user devices 102a-n to be restored to their initial values (e.g., to be increased or decreased to their initial values). Causing the modified registration intervals for the subset of the plurality of user devices 102a-n to be restored to their initial values may comprise sending (e.g., pushing) information indicating the initial registration interval for the subset of the plurality of user devices 102a-n back to the subset of the plurality of user devices 102a-n. For example, causing the modified registration intervals for the first user device to be restored to its initial values may comprise sending information indicating the first registration interval to the first user device. Each of the subset of the plurality of user devices 102a-n may receive the data indicating the initial registration interval. Each of the subset of the plurality of user devices 102a-n may attempt to re-register with the core network 109 based on its initial registration interval. Alternatively, if the computing device(s) 170 determine that the core network 109 is operating normally again, the computing device9s) 170 may maintain the modified registration intervals for the subset of the plurality of user devices 102a-n instead of restoring the registration intervals to their initial values.

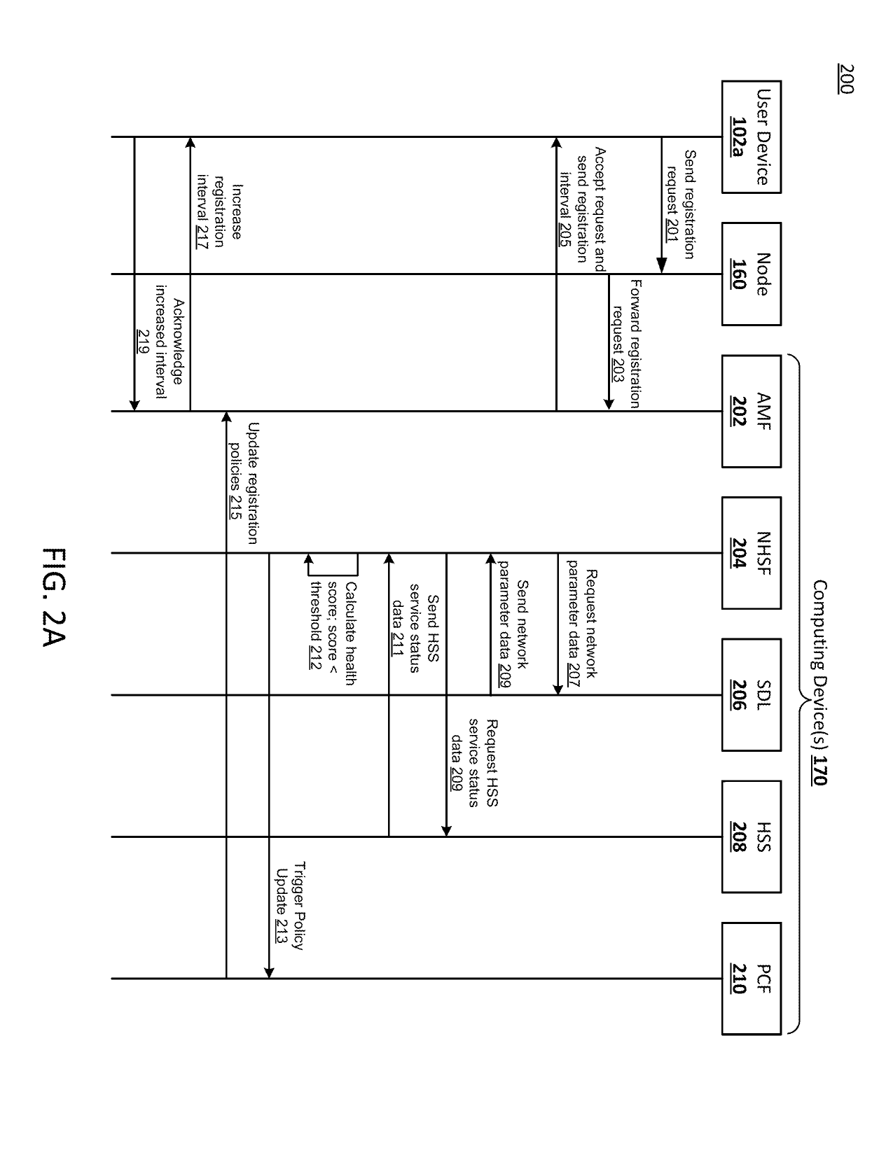

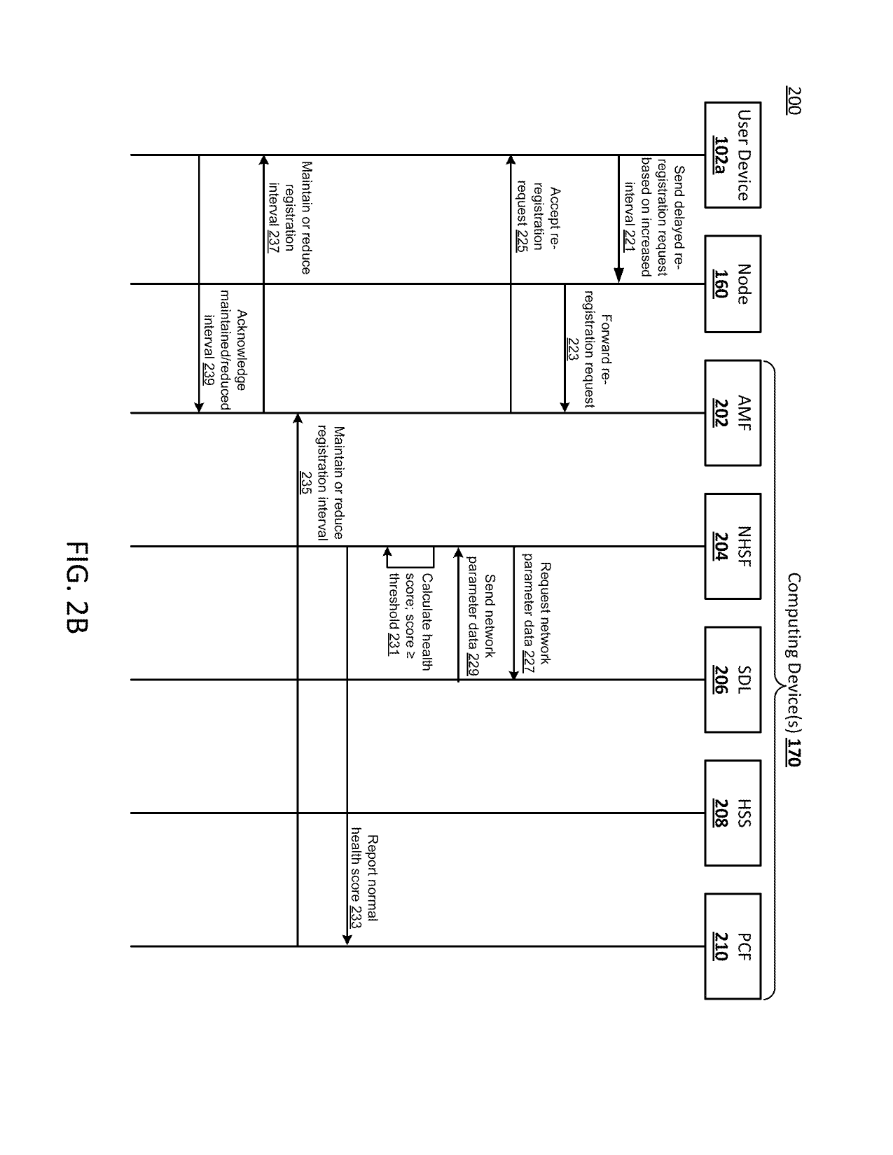

FIGS. 2A-B show an example method 200 for managing network registrations. At 201, the user device 102a may send a request to register with the core network 109. The user device 102a may send the registration request to the node(s) 160. At 203, the node(s) 160 may forward the registration request to the AMF 202. The AMF 202 may receive the registration request. The AMF 202 may accept the request to register with the core network 109. At 205, the AMF 202 may send a message back to the user device 102a indicating that the request is accepted. The AMF 202 may additionally send information indicating an initial registration interval for the user device 102a. The user device 102a may receive the data indicating the initial registration interval for the user device 102a. The user device 102a may periodically request to re-register with the core network 109 based on the initial registration interval.

The NHSF 204 may determine (e.g., monitor) the parameter(s) associated with the core network 109. The NHSF 204 may determine (e.g., monitor) the parameter(s) continuously, periodically, or at some interval. The parameter(s) may comprise one or more of a congestion level, a load on one or more network components (e.g., on the AMF 202, the SMF, the node(s) 160, and/or any other elements or functions of the core network 109), a latency level, a network speed, a throughput, or a level of packet loss. To determine (e.g., monitor) the network parameter(s), at 207, the NHSF 204 may send a request for data indicating values of the network parameter(s). The NHSF 204 may send the request for network parameter data to the SDL 206, for example. The SDL 206 may receive the request for the network parameter data. At 209, the SDL 206 may send data indicating the values of the network parameter(s) to the NHSF 204. The SDL 206 may send the data indicating the values of the network parameter(s) to the NHSF 204 based on (e.g., in response to) receiving the request for the network parameter data. At 209, the NHSF 204 may send a request for HSS service status data. The NHSF 204 may send the request for the HSS service status data to the HSS 208. The HSS 208 may receive the request for the HSS service status data. At 211, the HSS 208 may send the HSS service status data data to the NHSF 204.

At 212, the NHSF 204 may determine a health score associated with the core network 109. The computing device(s) 170 may determine a health score associated with the core network 109 based on the determined (e.g., monitored) parameter(s). The computing device(s) 170 may determine a health score associated with the core network 109 based on receiving the data indicating the values of the network parameter(s). Determining the health score associated with the core network 109 may comprise determining a value of a network health score function. The value of each of the network parameter(s) may be input into the network health score function. The network health score function may output the health score associated with the core network 109. If the health score satisfies (e.g., is equal to or above) a predetermined threshold, this may indicate that the core network 109 is not experiencing a service degradation. Conversely, if the health score does not satisfy (e.g., is less than) a predetermined threshold, this may indicate that the core network 109 is experiencing a service degradation.

The NHSF 204 may determine that the health score does not satisfy the threshold. At 213, the NHSF 204 may trigger a policy update. The NHSF 204 may trigger the policy update based on sending a message to the PCF 210. The NHSF 204 may trigger the policy update based on (e.g., in response to) determining that the health score does not satisfy the threshold. The PCF 210 may receive the message. At 215, the PCF 210 may send a message to the AMF 202. The message may indicate an update to the registration policies for the core network 109. For example, the message may indicate an increased registration interval for the user device 102a. At 217, the AMF 202 may send information indicating the increased registration interval to the user device 102a. The user device 102a may receive the information indicating the increased registration interval. At 219, the user device 102a may send an acknowledgement message to the AMF 202. The acknowledgement message may indicate that the user device 102a received the increased registration interval.

The user device 102a may attempt to re-register with the core network 109 based on the increased registration interval. At 221, the user device 102a may send a request to re-register with the core network 109 based on the increased registration interval. The user device 102a may send the re-registration request to the node(s) 160. At 223, the node(s) 160 may forward the re-registration request to the AMF 202. The AMF 202 may receive the re-registration request. The AMF 202 may accept the request to re-register with the core network 109. At 225, the AMF 202 may send a message back to the user device 102a indicating that the re-registration request is accepted.

The computing device(s) 170 (e.g., the NHSF) may continue to determine (e.g., monitor) the parameter(s) associated with the core network 109. At 227, the NHSF 204 may send a request for data indicating values of the network parameter(s). The NHSF 204 may send the request for the network parameter data to the SDL 206, for example. The SDL 206 may receive the request for the network parameter data. At 229, the SDL 206 may send data indicating the values of the network parameter(s) to the NHSF 204. The SDL 206 may send the data indicating the values of the network parameter(s) to the NHSF 204 based on (e.g., in response to) receiving the request for the network parameter data.

At 231, the NHSF 204 may determine an updated health score associated with the core network 109. The computing device(s) 170 may determine the updated health score associated with the core network 109 based on the determined (e.g., monitored) parameter(s). The computing device(s) 170 may determine the updated health score associated with the core network 109 based on receiving the data indicating the values of the network parameter(s). Determining the updated health score associated with the core network 109 may comprise determining an updated value of the network health score function. The network health score function may output the updated health score associated with the core network 109. If the update health score satisfies (e.g., is equal to or above) a predetermined threshold, this may indicate that the core network 109 is not experiencing a service degradation. Conversely, if the updated health score does not satisfy (e.g., is less than) a predetermined threshold, this may indicate that the core network 109 is experiencing a service degradation.

The NHSF 204 may determine that the updated health score satisfies the threshold. At 233, the NHSF 204 may trigger a policy update. The NHSF 204 may trigger the policy update based on sending a message to the PCF 210. The NHSF 204 may trigger the policy update based on (e.g., in response to) determining that the health score does not satisfy the threshold. The PCF 210 may receive the message. At 235, the PCF 210 may send a message to the AMF 202. The message may indicate an update to the registration policies for the core network 109. For example, the message may indicate an instruction to maintain or reduce the registration interval (e.g., reduce the registration interval back to the initial registration interval) for the user device 102a. At 237, the AMF 202 may send data indicating the maintained or reduced registration interval to the user device 102a. The user device 102a may receive the data indicating the maintained or reduced registration interval. At 239, the user device 102a may send an acknowledgement message to the AMF 202. The acknowledgement message may indicate that the user device 102a received the maintained or reduced registration interval. The user device 102a may attempt to re-register with the core network 109 based on the maintained or reduced registration interval.

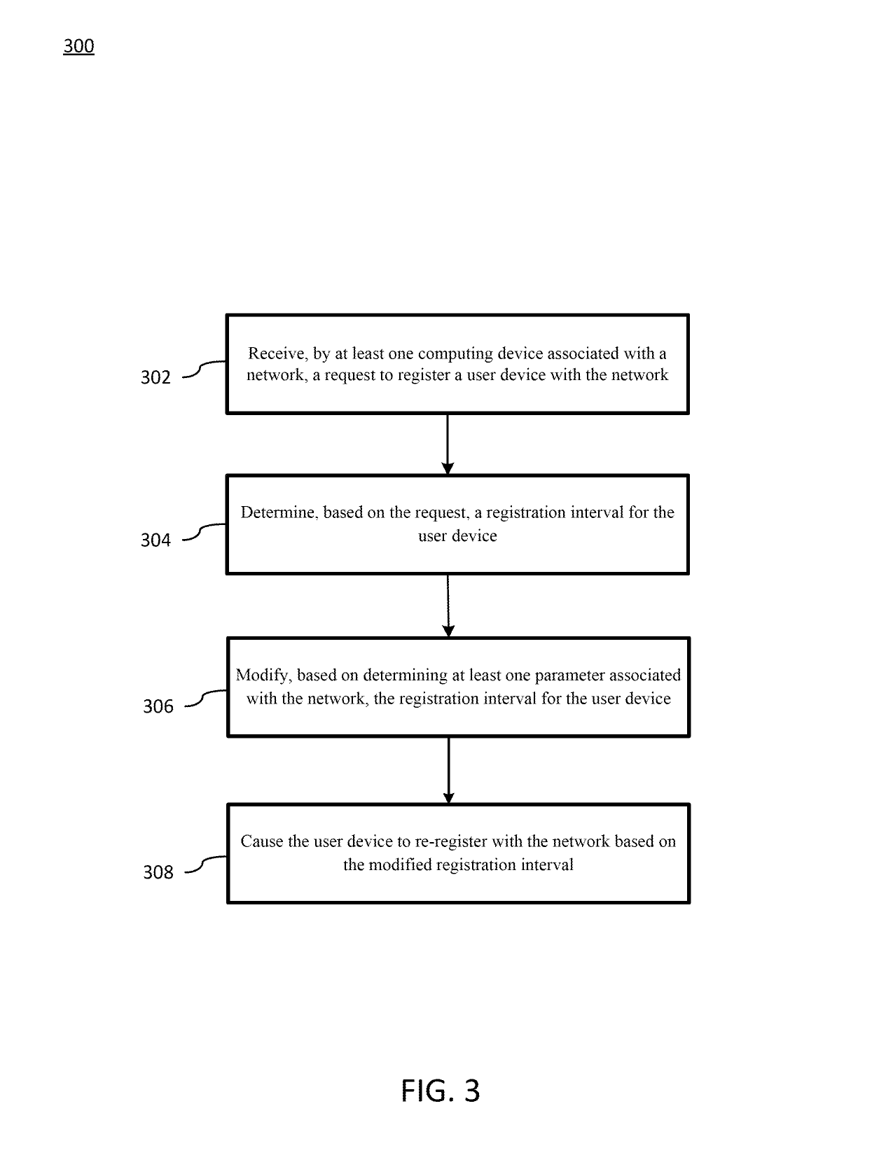

FIG. 3 shows an example method 300. The method 300 may comprise a computer implemented method for managing network registrations. A system and/or computing environment, such as the system 100 of FIG. 1 and/or the computing environment of FIG. 6, may be configured to perform the method 300. For example, the computing device(s) 170 of FIG. 1 may be configured to perform the method 300.

At 302, a request to register a user device with a network may be received. The request may be received by at least one computing device associated with the network. Based on (e.g., in response to) receiving the request to register the user device with the network, the user device may be connected to the network. At 304, a registration interval for the user device may be determined. The registration interval may be determined based on receiving the request. The registration interval for the user device may be determined based on as network conditions, mobility of the user device, and/or device type. Data indicating the registration interval may be send to the user device. The user device may periodically send a request to re-register with the network based on the registration interval.

At least one parameter associated with the network may be determined. Determining the at least one parameter may comprise continuously or periodically monitoring the at least one parameter. The at least one parameter may be determined by other means. The at least one parameter may comprise one or more of a congestion level, a load on one or more network components, a latency level, a network speed, a throughput, or a level of packet loss.

At 306, the registration interval for the user device may be modified. The registration interval for the user device may be modified based on determining (e.g., monitoring) the at least one parameter. For example, a health score associated with the network may be determined based on values of the determined (e.g., monitored) parameter(s). If the health score does not satisfy (e.g., is less than) a predetermined threshold, this may indicate that the network is experiencing a service degradation. The registration interval for the user device may be modified based on (e.g., in response to) determining that the network is experiencing a service degradation. A subscriber identifier (e.g., IMSI) associated with the user device may be determined. The registration interval for the user device may be modified based on determining that the subscriber identifier falls within a predetermined range of subscriber identifiers. Additionally, or alternatively, a priority level associated with the user device may be determined. The registration interval for the user device may be modified based on determining that the user device is associated with a low priority level.

At 308, the user device may be caused to re-register with the network based on the modified registration interval. Causing the user device to re-register with the network based on the modified registration interval may comprise sending information indicative of the modified registration interval to the user device. The user device may receive the information indicative of the modified registration interval. The user device may send a request to re-register with the network based on the modified registration interval.

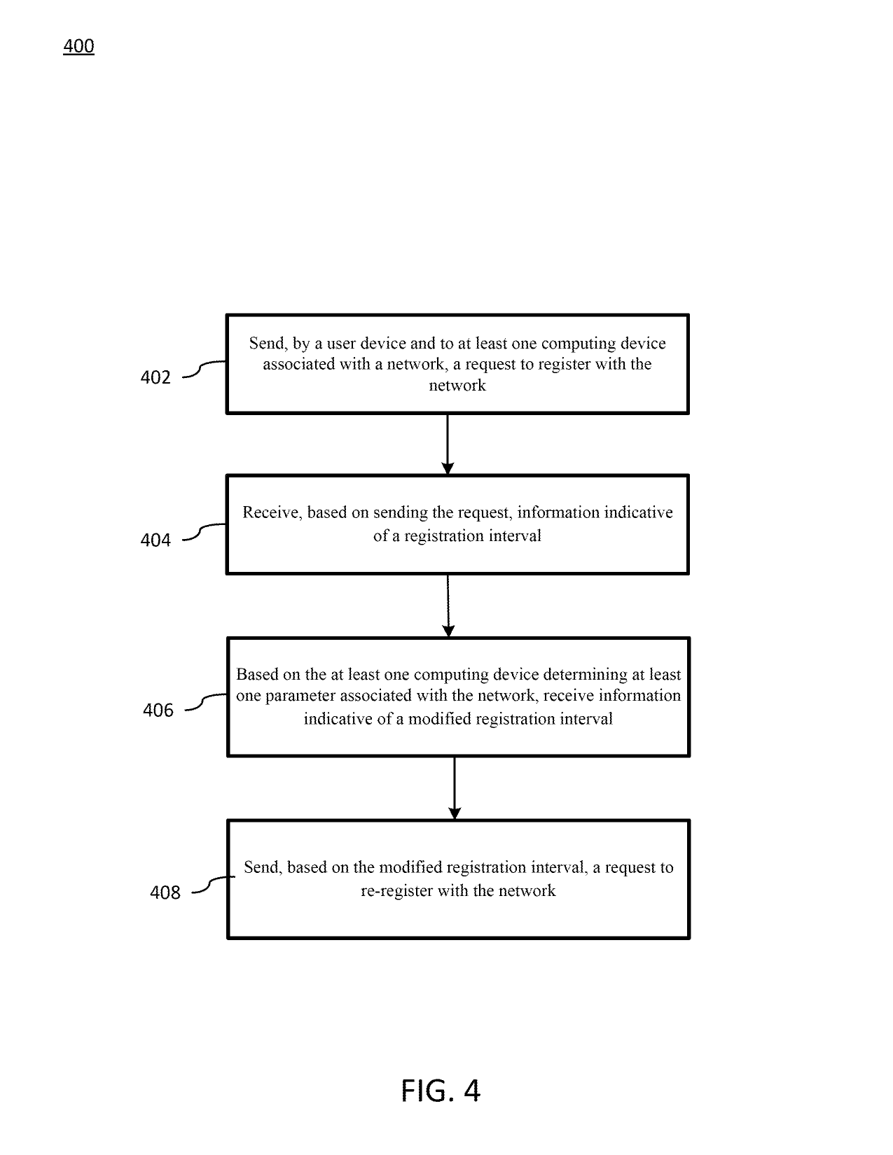

FIG. 4 shows an example method 400. The method 400 may comprise a computer implemented method for managing network registrations. A system and/or computing environment, such as the system 100 of FIG. 1 and/or the computing environment of FIG. 6, may be configured to perform the method 400. For example, any one of the plurality of user devices 102a-n of FIG. 1 may be configured to perform the method 400.

At 402, a request to register a user device with a network may be sent. The request may be sent to at least one computing device associated with the network. Based on (e.g., in response to) receiving the request to register the user device with the network, the user device may be connected to the network. At 404, information indicating a registration interval for the user device may be received. The information indicating the registration interval may be received based on sending the request. For example, the information indicating the registration interval may be received based on the user device connecting to the network. The registration interval for the user device may be determined based on as network conditions, mobility of the user device, and/or device type. The user device may periodically send a request to re-register with the network based on the registration interval.

The computing device(s) associated with the network may continuously or periodically determine (e.g., monitor) at least one parameter associated with the network. The at least one parameter may comprise one or more of a congestion level, a load on one or more network components, a latency level, a network speed, a throughput, or a level of packet loss. At 406, information indicating a modified registration interval may be received. Receiving the modified registration interval for the user device may be based on a subscriber identifier associated with the user device falling within a predetermined range of subscriber identifiers. Receiving the modified registration interval for the user device may be based on a priority level associated with the user device indicating that the user device is a low-priority device.

The information indicating the modified registration interval may be received from the computing device(s). For example, the computing device(s) associated with the network may determine a health score associated with the network based on values of the parameter(s). If the health score does not satisfy (e.g., is less than) a predetermined threshold, this may indicate that the network is experiencing a service degradation. The computing device(s) may modify the registration interval for the user device based on (e.g., in response to) determining that the network is experiencing a service degradation. The computing device(s) may send the information indicating the modified registration interval to the user device. The user device may be caused to re-register with the network based on receiving the information indicative of the modified registration interval. At 408, the user device may send a request to re-register with the network. The user device may send the request to re-register with the network to the computing device(s). The user device may send the request to re-register with the network based on the modified registration interval.

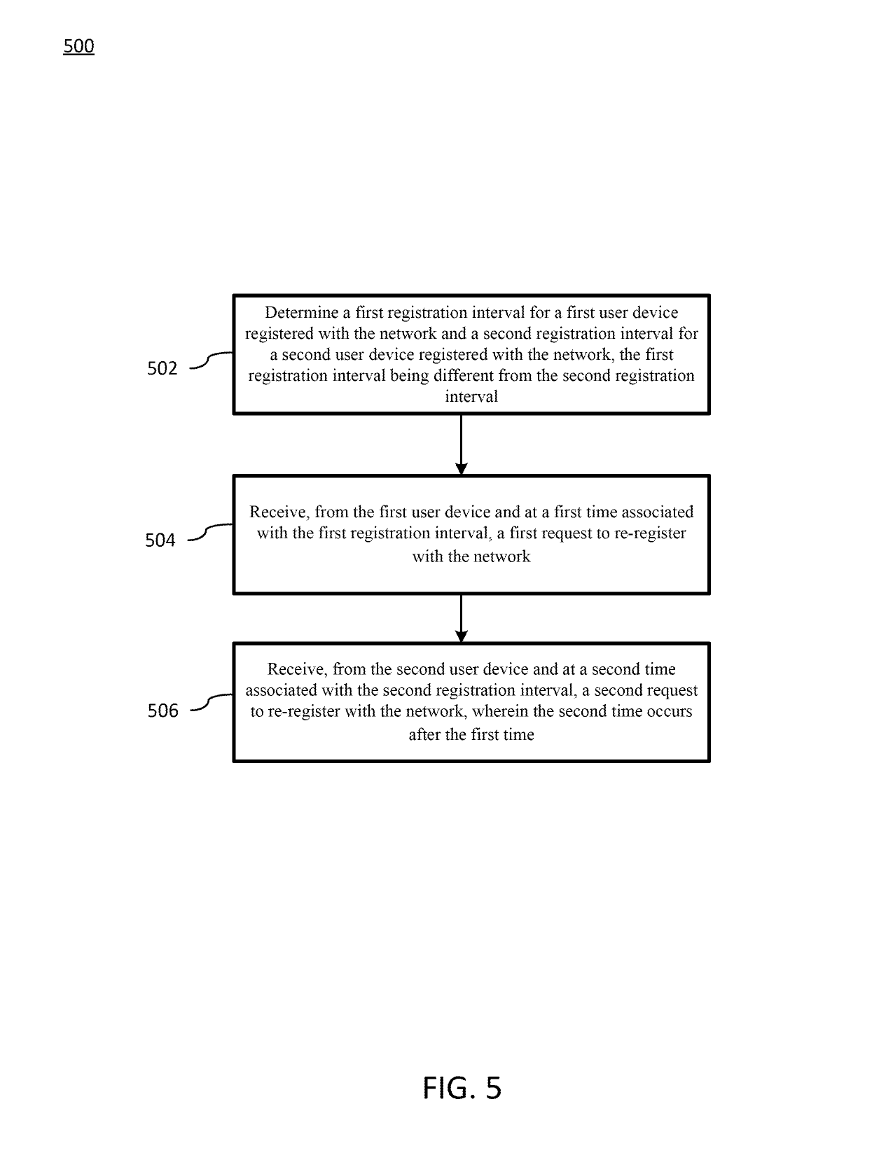

FIG. 5 shows an example method 500. The method 500 may comprise a computer implemented method for managing network registrations. A system and/or computing environment, such as the system 100 of FIG. 1 and/or the computing environment of FIG. 6, may be configured to perform the method 500. For example, the computing device(s) 170 of FIG. 1 may be configured to perform the method 500.

A plurality of user devices may be registered with a network. At least one parameter associated with the network may be continuously or periodically determined (e.g., monitored). The at least one parameter may comprise one or more of a congestion level, a load on one or more network components, a latency level, a network speed, a throughput, or a level of packet loss. A health score associated with the network may be determined based on values of the determined (e.g., monitored) parameter(s). If the health score does not satisfy (e.g., is less than) a predetermined threshold, this may indicate that the network is experiencing a service degradation. The registration interval for a subset of the plurality of user devices may be modified based on (e.g., in response to) determining that the network is experiencing a service degradation.

To determine the subset of the plurality of user devices for which to modify the registration interval, a range of subscriber identifiers, such as a range of Subscriber Identity Modules (SIMs), may be determined. The subset of the plurality of user devices may comprise the user devices associated with a subscriber identifier that falls within the range of subscriber identifiers. Additionally, or alternatively, to determine the subset of the plurality of user devices for which to modify the registration interval, a priority level associated with each of the plurality of user devices may be determined. The priority level associated with each user device among the plurality of user devices may indicate if that user device is a high priority user device or a low priority user device. High priority user devices may comprise user devices associated with emergency services, user devices associated with enterprise applications, critical IoT devices, and/or the like. Low priority user devices may comprise user devices that are idle, user devices that are considered to be non-essential, and/or any other user devices that have not been assigned a high priority level. The subset of the plurality of user devices may comprise the user devices associated with a low priority level.

The subset of the plurality of user devices may comprise a second user device among the plurality of user devices, but not a first user device among the plurality of user devices. For example, the second user device, but not the first user device, may be associated with a subscriber identifier that falls within the range of subscriber identifiers. Additionally, or alternatively, the second user device, but not the first user device, may be associated with a low priority level. At 502, a first registration interval for the first user device may be determined. The first registration interval for the first user device may comprise an initial registration interval for the first user device (e.g., the registration interval determined for the first user device when the first user device initially registered with the network). A second registration interval for the second user device may be determined. Determining the second registration interval for the second user device may comprise modifying an initial registration interval associated with the second user device. For example, determining the second registration interval may comprise increasing an initial registration interval associated with the second user device. The second registration interval may be different from the first registration interval

The first user device may re-register with the network based on the first registration interval. To re-register with the network, the first user device may send a request to re-register with the network based on the first registration interval (e.g., the registration interval determined for the first user device when the first user device initially registered with the network). At 504, a first request to re-register with the network may be received. The first request may be received from the first user device. The first request to re-register with the network may be received at a first time.

The second user device may re-register with the network based on the second registration interval. To re-register with the network, the second user device may send a request to re-register with the network based on the second registration interval (e.g., the increased registration interval determined for the second user device at 502). At 506, a second request to re-register with the network may be received. The second request may be received from the second user device. The second request to re-register with the network may be received at a second time. The second time may occur after the first time. Staggering re-registration attempts from the plurality of user devices in this manner may prevent a registration storm and/or may prevent the registration storm from escalating and spreading to other parts of the network. This localized control may prevent cascading failures and may ensure stability of the network.

FIG. 6 shows an example computing device 600 that may represent any of the various devices or entities shown in FIG. 1, including, for example, the plurality of user devices 102a-n, the RAN 104, the node(s) 160, the core network 109, the computing device(s) 170, and/or the network 180. That is, the computing device 600 shown in FIG. 6 may be any smartphone, server computer, workstation, access point, router, gateway, tablet computer, IoT device, laptop computer, notebook computer, desktop computer, personal computer, television, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 2A-5.

The computing device 600 may include a baseboard, or “motherboard,” which is a printed circuit board to which a multitude of components or devices may be connected by way of a system bus or other electrical communication paths. One or more central processing units (CPUs or “processors”) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random-access memory (RAM) 608 used as the main memory in the computing device 600. The chipset 606 may provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622. A NIC 622 may be capable of connecting the computing device 600 to other computing nodes over the network 616. It should be appreciated that multiple NICs 622 may be present in the computing device 600, connecting the computing device to other types of networks and remote computer systems. The NIC may be configured to implement a wired local area network technology, such as IEEE 802.3 (“Ethernet”) or the like. The NIC 622 may also comprise any suitable wireless network interface controller capable of wirelessly connecting and communicating with other devices or computing nodes on the system 100. For example, the NIC 622 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, one or more Bluetooth protocols, and/or the like.

The computing device 600 may be connected to a mass storage device 626 that provides non-volatile storage (i.e., memory) for the computer. The mass storage device 626 may store system programs, application programs, other program modules, and data, which have been described in greater detail herein. The mass storage device 626 may be connected to the computing device 600 through a storage controller 624 connected to the chipset 606. The mass storage device 626 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 626 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 626 is characterized as primary or secondary storage and the like.

For example, the computing device 600 may store information to the mass storage device 626 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may read information from the mass storage device 626 by detecting the physical states or characteristics of one or more particular locations within the physical storage units.

In addition to the mass storage device 626 described herein, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 626 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 626 may store other system or application programs and data utilized by the computing device 600.

The mass storage device 626 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described herein. The computing device 600 may have access to computer-readable storage media storing computer-executable instructions, which, when executed by the computing device 600, may perform the methods described in relation to FIGS. 2A-5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing device may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey data indicating a preferred or ideal embodiment. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described above with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are shown as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the shown computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by at least one computing device associated with a network, a request to register a user device with the network;
determining, by the at least one computing device and based on the request, a registration interval for the user device;
modifying, by the at least one computing device and based on determining at least one parameter associated with the network, the registration interval for the user device; and
causing the user device to re-register with the network based on the modified registration interval.

2. The method of claim 1, further comprising determining, based on the at least one determined parameter, a health score associated with the network, wherein modifying the registration interval for the user device is based on determining that the health score does not satisfy a threshold.

3. The method of claim 1, wherein the at least one parameter associated with the network comprises one or more of a congestion level, a load on one or more components of the network, a latency level, a network speed, a throughput, or a level of packet loss.

4. The method of claim 1, further comprising determining a subscriber identifier associated with the user device, wherein modifying the registration interval for the user device is based on determining that the subscriber identifier falls within a predetermined range of subscriber identifiers.

5. The method of claim 1, further comprising determining a priority level associated with the user device, wherein modifying the registration interval for the user device is based on the priority level indicating that the user device is a low-priority device.

6. The method of claim 1, wherein causing the user device to re-register with the network based on the modified registration interval comprises sending information indicative of the modified registration interval to the user device.

7. The method of claim 1, wherein the network comprises a 5G network.

8. The method of claim 1, wherein the user device comprises at least one of a mobile device, a smart phone, a tablet computer, a portable gaming device, or a wearable computing device.

9. A method comprising:
sending, by a user device and to at least one computing device associated with a network, a request to register with the network;
receiving, based on sending the request, information indicative of a registration interval;
based on the at least one computing device determining at least one parameter associated with the network, receiving information indicative of a modified registration interval; and
sending, based on the information indicative of the modified registration interval, a request to re-register with the network.

10. The method of claim 9, wherein the at least one parameter associated with the network comprises one or more of a congestion level, a load on one or more components of the network, a latency level, a network speed, a throughput, or a level of packet loss.

11. The method of claim 9, wherein receiving the information indicative of the modified registration interval for the user device is based on a subscriber identifier associated with the user device falling within a predetermined range of subscriber identifiers.

12. The method of claim 9, wherein the user device is associated with a priority level, and wherein receiving the information indicative of the modified registration interval for the user device is based on the priority level indicating that the user device is a low-priority device.

13. The method of claim 9, wherein the network comprises a 5G network.

14. The method of claim 9, wherein the user device comprises at least one of a mobile device, a smart phone, a tablet computer, a portable gaming device, or a wearable computing device.

15. A method comprising:
determining, based on determining at least one parameter associated with a network, a first registration interval for a first user device registered with the network and a second registration interval for a second user device registered with the network, wherein the first registration interval is different from the second registration interval;
receiving, from the first user device and at a first time associated with the first registration interval, a first request to re-register with the network; and
receiving, from the second user device and at a second time associated with the second registration interval, a second request to re-register with the network, wherein the second time occurs after the first time.

16. The method of claim 15, further comprising:
determining, based on the at least one determined parameter, a health score associated with the network, wherein determining the first registration interval for the first user device registered with the network and the second registration interval for the second user device registered with the network is based on determining that the health score does not satisfy a threshold.

17. The method of claim 15, wherein the at least one parameter associated with the network comprises one or more of a congestion level, a load on one or more components of the network, a latency level, a network speed, a throughput, or a level of packet loss.

18. The method of claim 15, further comprising:
sending information indicative of the first registration interval to the first user device to cause the first user device to send the first request to re-register with the network; and
sending information indicative of the second registration interval to the second user device to cause the second user device to send the second request to re-register with the network.

19. The method of claim 15, wherein the network comprises a 5G network.

20. The method of claim 15, wherein the first user device and the second user device each comprise at least one of a mobile device, a smart phone, a tablet computer, a portable gaming device, or a wearable computing device.
